(19) United States
(12) Patent Application Publication
(10) Pub. No.: US 2014/0168590 A1
(43) Pub. Date: Jun. 19, 2014

(54) LIQUID CRYSTAL DISPLAY PANEL

(71) Applicant: AU Optronics Corp., Hsin-Chu (TW)

(72) Inventors: Kuan-Ming Chen, Hsin-Chu (TW); Szu-Yu Lin, Hsin-Chu (TW); Te-Jen Tseng, Hsin-Chu (TW)

(21) Appl. No.: 13/914,645

(22) Filed: Jun. 11, 2013

(30) Foreign Application Priority Data
Dec. 14, 2012 (TW) 101147547

(51) Int. Cl. G02F 1/1343

(52) U.S. Cl. CPC G02F 1/1343
USPC 349/138

(57) ABSTRACT

A liquid crystal display panel includes a first substrate, a second substrate, a liquid crystal layer, and an electrode structure. The liquid crystal layer is disposed between the first substrate and the second substrate. The electrode structure is disposed between the first substrate and the second substrate, and the electrode structure is used to generate a horizontal electric field for driving the liquid crystal layer. The electrode structure includes a plurality of sub-electrodes. Each of the sub-electrodes includes a first conductive pattern, a second conductive pattern, and a first insulating layer. The first and the second conductive patterns are disposed in a stack configuration along a vertical projective direction perpendicular to the first substrate and the second substrate. An area of the first conductive pattern is larger than an area of the second conductive pattern. The first insulating layer is disposed between the first and the second conductive patterns.

### BACKGROUND OF THE INVENTION

1. Field of the Invention

The present invention relates to a liquid crystal display panel, especially to a liquid crystal display panel using protruding sub-electrodes to enhance a horizontal electric field formed between the sub-electrodes.

2. Description of the Prior Art

With the evolution of the liquid crystal display technology, the liquid crystal display panel has been widely used in flat-screen televisions, notebook computers, mobile phones and various types of consumer electronics products. The conventional liquid crystal display panels use liquid crystal molecules having optical anisotropy characteristics, apply an electric field to drive the liquid crystal molecules rotate to a different state arrangement, and then a polarizing film is used to present the bright state and dark state effects. Usually the response time of the liquid crystal molecules is longer than 10 milliseconds, so the update frequency of the liquid crystal display is limited.

In order to solve the issue about the response time, a blue-phase liquid crystal display panel had been developed recently. The blue-phase is a liquid crystal state between the isotropic phase and the cholesteric phase; it is an unstable state. Furthermore, the blue-phase liquid crystal has three-dimensional lattice characteristics but still has fluid characteristics, so the lattice constant is therefore easily changeable, and the blue-phase liquid crystal has a quick response time. For example, the positive-type blue phase liquid crystal maintains an optical isotropic state when the electric field is not applied, whereas a polarizing plate keeps it in a normally black state in similar conditions. In contrast, when a horizontal electric field is applied to the positive blue-phase liquid crystal, its birefringence (Δn) is changed and it presents a bright state. However, the operating voltage to drive the blue-phase liquid crystal is high (about 35 volts), thereby causing many problems because of high operating voltage.

### SUMMARY OF THE INVENTION

One main purpose of the present invention is to provide a liquid crystal display panel, using an insulating layer disposed between two conductive patterns to form protruding sub-electrodes, and to enhance the horizontal electric field formed between the sub-electrodes, so as to reduce the operating voltage.

To achieve the purpose mentioned above, the present invention provides a liquid crystal display panel including a first substrate, a second substrate disposed opposite to the first substrate, a liquid crystal layer disposed between the first substrate and the second substrate, and an electrode structure disposed between the first substrate and the second substrate; the electrode structure is used to generate a horizontal electric field for driving the liquid crystal layer, wherein the electrode structure includes a plurality of sub-electrodes. Each of the sub-electrodes includes a first conductive pattern, a second conductive pattern, and a first insulating layer. The first conductive pattern and the second conductive pattern are disposed in a stack configuration along a vertical projective direction perpendicular to the first substrate and the second substrate. An area of the first conductive pattern is larger than an area of the second conductive pattern, and the first insulating layer is disposed between the first conductive pattern and the second conductive pattern.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a liquid crystal display panel according to the first embodiment of the present invention.

FIG. 2 is a schematic diagram showing a liquid crystal display panel according to the second embodiment of the present invention.

FIG. 3 is a top-view schematic diagram showing a liquid crystal display panel according to the second embodiment of the present invention.

FIG. 4 is a cross-sectional schematic diagram accordance with the section line A-A′ of FIG. 3.

FIG. 5 is a schematic diagram showing a liquid crystal display panel according to the third embodiment of the present invention.

FIG. 6 is a schematic diagram showing a liquid crystal display panel according to the fourth embodiment of the present invention.

FIG. 7 is a schematic diagram showing curves about relations between the transmittance and the driving voltage of the liquid crystal display panel according to the second, third and fourth embodiment of the present invention and a liquid crystal display panel of a control group.

FIG. 8 is a schematic diagram showing a liquid crystal display panel according to the fifth embodiment of the present invention.

FIG. 9 is a schematic diagram showing a liquid crystal display panel according to the sixth embodiment of the present invention.

FIG. 10 is a schematic diagram showing a liquid crystal display panel according to the seventh embodiment of the present invention.

FIG. 11 is a schematic diagram showing a liquid crystal display panel according to the eighth embodiment of the present invention.

### DETAILED DESCRIPTION

To provide a better understanding of the present invention to users skilled in the technology of the present invention, embodiments are detailed as follows. The embodiments of the present invention are illustrated in the accompanying drawings with numbered elements to clarify the contents and the effects to be achieved.

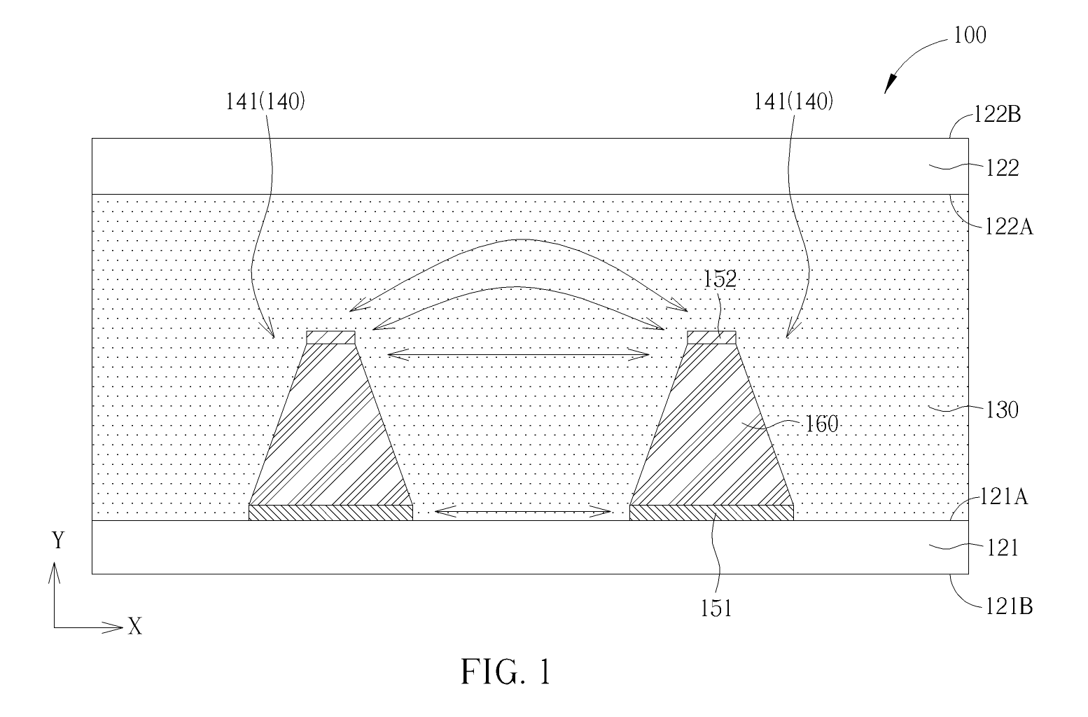

Please refer to FIG. 1; FIG. 1 is a schematic diagram showing a liquid crystal display panel according to the first embodiment of the present invention. As shown in FIG. 1, the liquid crystal display panel 100 of the present includes a first substrate 121, a second substrate 122, a liquid crystal layer 130 and an electrode structure 140. The second substrate 122 is disposed opposite to the first substrate 121. The first substrate 121 has an inner surface 121A and an outer surface 121B; the second substrate 122 has an inner surface 122A and an outer surface 122B, and the inner surface 121A is disposed opposite to the inner surface 122A. The liquid crystal layer 130 is disposed between the first substrate 121 and the second substrate 122. The electrode structure 140 is disposed between the first substrate 121 and the second substrate 122 to generate a horizontal electric field for driving the liquid crystal layer 130. The liquid crystal layer 130 of the present invention may include blue phase liquid crystal, nematic liquid crystal or other suitable liquid crystal materials. The product of the birefringence (Δn) to the dielectric anisotropy (Δ∈) of the liquid crystal layer 130 is preferably larger than or equal to 0.5, but not limited thereto. In this embodiment, the electrode structure 140 includes a plurality of sub-electrodes 141. Each sub-electrode 141 further includes a first conductive pattern 151, a second conductive pattern 152 and a first insulating layer 160. The first insulating layer 160 is disposed between the first conductive pattern 151 and the second conductive pattern 152. The second conductive pattern 152 and the first conductive pattern 151 are disposed in a stack configuration along a vertical projective direction Y perpendicular to the first substrate 121 and the second substrate 122. Along the vertical projective direction Y, the area of the first conductive pattern 151 is larger than the area of the second conductive pattern 152.

In this embodiment, each sub-electrode 141 is disposed on the first substrate 121, but not limited to, and the sub-electrodes 141 may be disposed on the same or on a different surface according to actual requirements. Each sub-electrode 141 on the first substrate 121 of the present invention is used to form the horizontal electric field between the sub-electrodes 141 for driving the liquid crystal layer 130. Each first conductive pattern 151 of each sub-electrode 141 is disposed between the first substrate 121 and the first insulating layer 160, and when observed along the vertical projective direction Y from the first substrate 121 side, the second conductive pattern 152 is entirely hidden by the first conductive pattern. In other words, the first conductive pattern 151, the first insulating layer 160 and the second conductive pattern 152 of each sub-electrode 141 are stacked from bottom to top in sequence on the substrate 121. The first conductive pattern 151 and the second conductive pattern 152 may comprise transparent conductive material such as indium tin oxide (ITO), indium zinc oxide (IZO), aluminum zinc oxide (AZO), indium gallium zinc oxide (IGZO) or other non-transparent conductive materials such as silver, aluminum, copper, magnesium, molybdenum, titanium, or alloys of the materials mentioned above, but not limited thereto. The material of the first insulating layer 160 may comprise inorganic materials such as silicon nitride, silicon oxide and silicon oxynitride, or organic materials such as acrylic resin or other suitable materials. The first substrate 121 and the second substrate 122 are array substrates, color filter substrates or color filter on array substrates (COA substrate), but not limited thereto. Besides, the first insulating layer 160 of each sub-electrode 141 is at least partially uncovered by the second conductive pattern 152 on the sides along a horizontal direction X parallel to the first substrate 121 and the second substrate 122, and the first conductive pattern 151 of each sub-electrode 141 is electrically isolated from the second conductive pattern 152, but not limited thereto.

It is worth noting that the distance between the first substrate 121 and the second substrate 122 is preferably larger than or equal to 0.5 micrometer, the distance between the first conductive pattern 151 and the second conductive pattern 152 of each sub-electrode 141 is preferably larger than or equal to 0.1 micrometer, and the distance between two adjacent sub-electrodes 141 is preferably larger than or equal to 0.5 micrometer, to achieve better driving performances. In other words, in this embodiment, the sub-electrodes 141 use the first insulating layer 160 to increase the distance between the second conductive pattern 152 and the first substrate 121, so as to make the sub-electrodes 141 form protrusion shaped sub-electrodes on the inner surface 121A of the first substrate 121, so the sub-electrodes 141 can be embedded deeper in the liquid crystal layer 130 along the vertical projective direction Y, and to improve the driving performances of the horizontal electric field formed between the sub-electrodes 141 to drive the liquid crystal layer 130. Therefore, the liquid crystal display panel 100 of the present embodiment can reduce the operating voltage. It is worth noting that the first insulating layers 160 of each sub-electrode 141 of the embodiment is does not contact one another, so as to have the liquid crystal layer 130 sufficiently fill the space between the sub-electrodes 141, and to improve the driving performances of the horizontal electric field formed between the sub-electrodes 141. Besides, in this embodiment, an area of the first conductive pattern 151 is larger than an area of the second conductive pattern 152, which not only reduces the process complexity, but also enhances the transmittance.

In this embodiment, the first conductive pattern 151 and the second conductive pattern 152 of each sub-electrode 141 may be applied by the same driving voltage or different driving voltages in order to form the horizontal electric field between two adjacent sub-electrodes 141. The driving voltage mentioned above comprises a positive driving voltage and a negative driving voltage or common voltage, but not limited thereto. For example, a positive driving voltage and a negative driving voltage may be respectively applied to the first conductive pattern 151 and the second conductive pattern 152 of one sub-electrode 141, and a negative driving voltage and a positive driving voltage may be respectively applied to the first conductive pattern 151 and the second conductive pattern 152 of an adjacent sub-electrode 141 in order to form the horizontal electric field between these two adjacent sub-electrodes 141. In another case, a positive driving voltage may be applied simultaneously to the first conductive pattern 151 and the second conductive pattern 152 of one sub-electrode 141, and a negative driving voltage may be applied simultaneously to the first conductive pattern 151 and the second conductive pattern 152 of an adjacent sub-electrode 141 in order to form the horizontal electric field between these two adjacent sub-electrodes 141, but the present invention is not limited to the driving voltage composition mentioned above. A suitable driving voltage may be applied to the first conductive pattern 151 and the second conductive pattern 152 of each sub-electrode 141 in order to form the required horizontal electric field. It is worth noting that when the liquid crystal layer 130 is a blue-phase liquid crystal, the liquid crystal layer 130 is optically isotropic when the electric field is not applied, and may be combined with a suitable polarizer (not shown) to display the normally black mode. On the other hand, when the liquid crystal layer 130 is driven by the horizontal electric field between the sub-electrodes 141, a bright mode is displayed, but not limited thereto. Therefore, the liquid crystal display panel 100 of the present embodiment uses the structure of the sub-electrodes 141 to reduce the operating voltage and enhance the transmittance.

The following description will detail the different embodiments of the liquid crystal display panel of the present invention. To simplify the description, the following description will detail the dissimilarities among the different embodiments and the identical features will not be redundantly described. In order to compare the differences between the embodiments easily, the identical components in each of the following embodiments are marked with identical symbols.

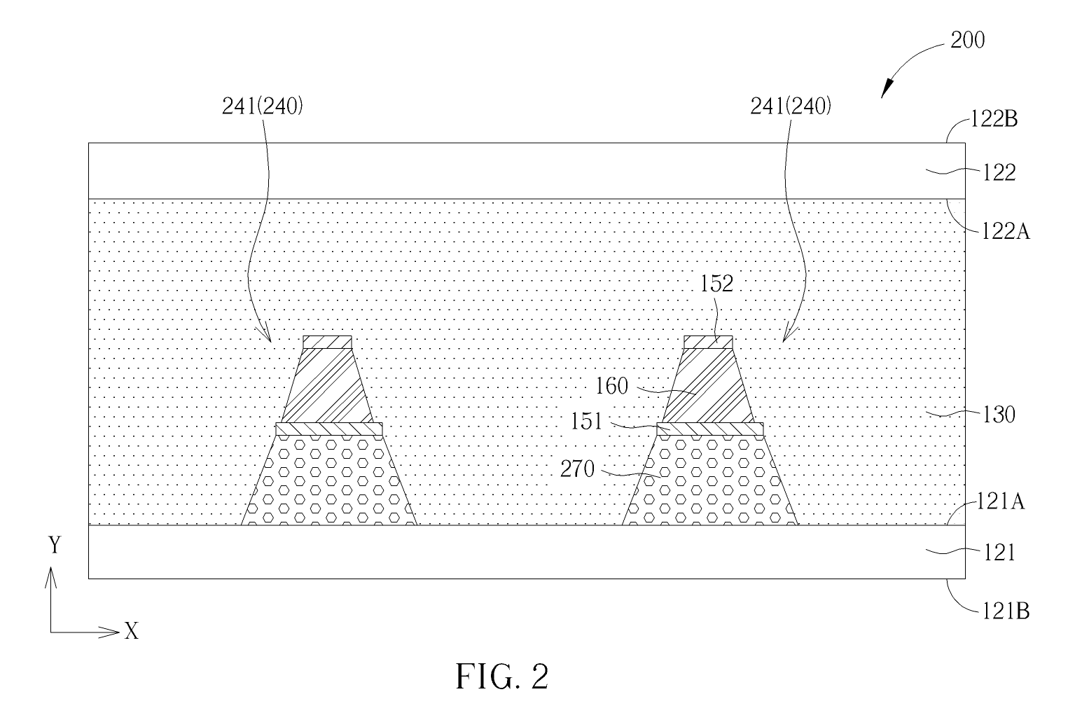

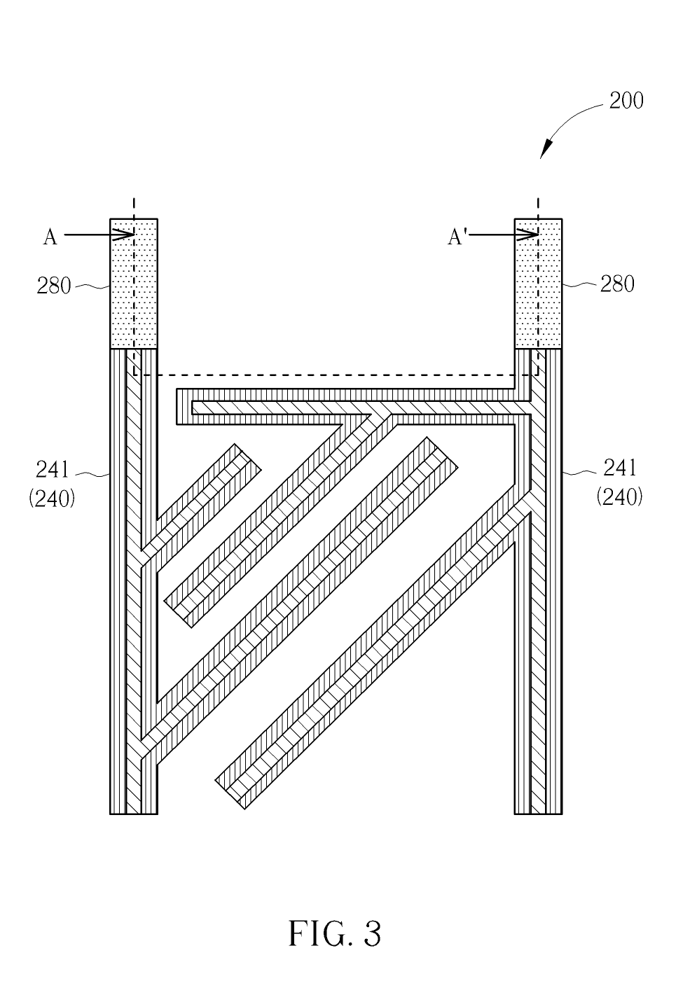

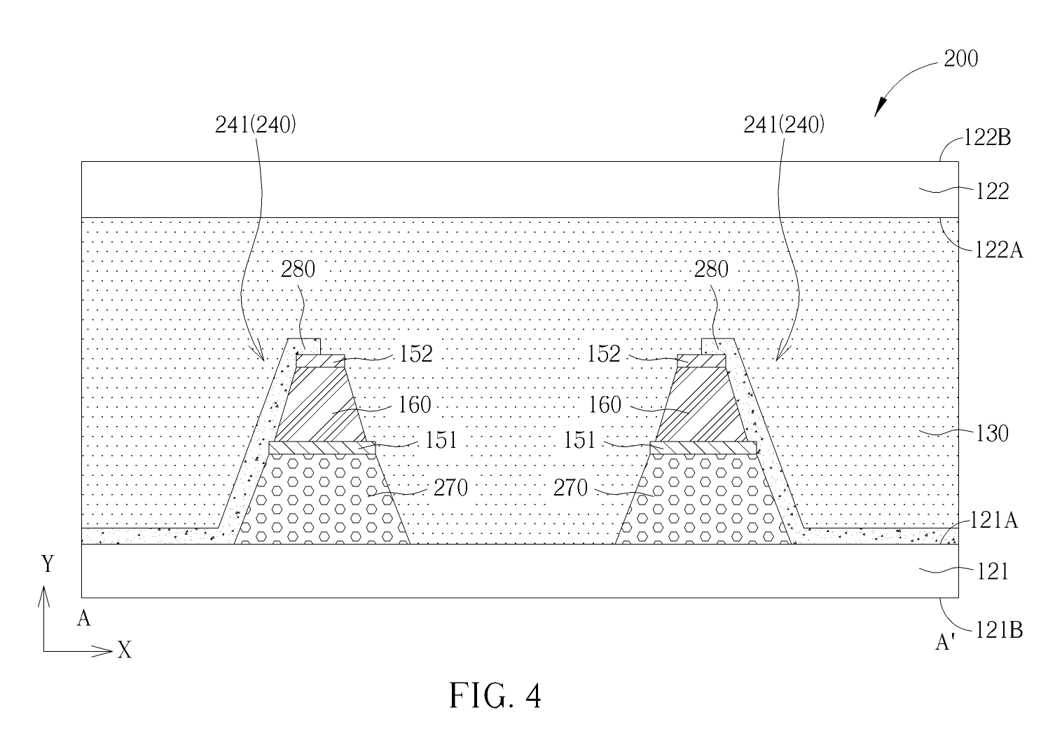

Please refer to FIGS. 2-4. FIG. 2 is a schematic diagram showing a liquid crystal display panel according to the second embodiment of the present invention. FIG. 3 is a top-view schematic diagram showing a liquid crystal display panel according to the second embodiment of the present invention. FIG. 4 is a cross-sectional diagram in accordance with the section line A-A′ of FIG. 3. As shown in FIG. 2, a liquid crystal display panel 200 of the present embodiment comprises the first substrate 121, the second substrate 122, the liquid crystal layer 130 and an electrode structure 240. The electrode structure 240 is disposed between the first substrate 121 and the second substrate 122 to form a horizontal electric field for driving the liquid crystal layer 130. The electrode structure 240 includes a plurality of the sub-electrodes 241 disposed on the inner surface 121A of the first substrate 121; each sub-electrode 241 includes a first conductive pattern 151, a second conductive pattern 152 and a first insulating layer 160. The difference between this embodiment and the first embodiment is that, in this embodiment, the sub-electrodes 241 further comprise a second insulating layer 270 disposed between the first substrate 121 and the first conductive pattern 151. The second insulating layer 270 of each sub-electrode 241 is at least partially uncovered by the first conductive pattern 151 and the second conductive pattern 152 along the horizontal direction X. In other words, the second insulating layer 270, the first conductive pattern 151, the first insulating layer 160 and the second conductive pattern 152 of each sub-electrode 241 are stacked from bottom to top in sequence on the substrate 121. The first conductive pattern 151 of each sub-electrode 241 of the present embodiment does not contacts the inner surface 121A of the first substrate 121 directly, and each sub-electrode 141 uses the second insulating layer 270 to increase the distance between the first conductive pattern 151 and the first substrate 121, and to increase the distance between the second conductive pattern 152 and the first substrate 121 respectively, so as to allow the sub-electrodes 241 to be embedded deeper in the liquid crystal layer 130 along the vertical projective direction Y, thereby improving the driving performances of the horizontal electric field formed between the sub-electrodes 241 to drive the liquid crystal layer 130.

As shown in FIGS. 3-4, the liquid crystal display panel 200 may further comprise a plurality of traces 280 electrically connected to the sub-electrodes 241 correspondingly. Through the connected traces 280 of the first conductive pattern 151 and the second conductive pattern 152 of each sub-electrode 241, a common driving voltage can be applied to the first conductive pattern 151 and the second conductive pattern 152 of each sub-electrode 241, but not limited thereto. Another terminal of each trace 280 is electrically connected to a switch element (not shown), such as a thin film transistor, to provide the driving voltage to the corresponding sub-electrode 241, but not limited thereto. Besides, two adjacent sub-electrodes 241 may be a “comb shaped” structure, disposed interlaced with each other for generating the horizontal electric field to achieve better performances, but not limited thereto. In this embodiment, apart from the second insulating layer 270, the other components, material properties, and manufacturing methods of the liquid crystal display panel 200 are similar to those of the first embodiment detailed above and will not be redundantly described. It is worth noting that the second insulating layers 270 of each sub-electrode 241 of the embodiment do not contact one another, so as to have the liquid crystal layer 130 sufficiently fill the space between the sub-electrodes 241, thereby improving the driving performances of the horizontal electric field formed between the sub-electrodes 241.

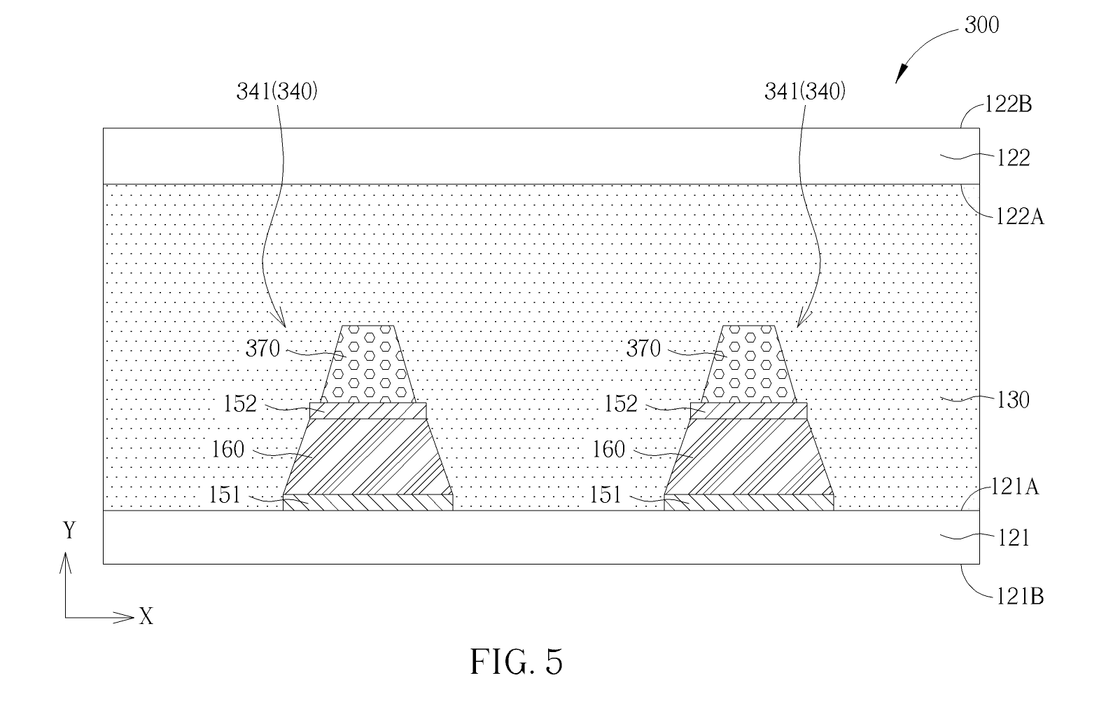

Please refer to FIG. 5; FIG. 5 is a schematic diagram showing a liquid crystal display panel according to the third embodiment of the present invention. As shown in FIG. 5, a liquid crystal display panel 300 comprises a first substrate 121, a second substrate 122, a liquid crystal layer 130 and an electrode structure 340. The electrode structure 340 is disposed between the first substrate 121 and the second substrate 122, to form a horizontal electric field for driving the liquid crystal layer 130. The electrode structure 340 includes a plurality of sub-electrodes 341 disposed on the inner surface 121A of the first substrate 121, wherein each sub-electrode 341 includes a first conductive pattern 151, a second conductive pattern 152 and a first insulating layer 160. The difference between this embodiment and the first embodiment is that, in this embodiment, the sub-electrodes 341 further comprise a second insulating layer 370 disposed on the second conductive pattern 152, and the second conductive pattern 152 is disposed between the first insulating layer 160 and the second insulating layer 370. In other words, the first conductive pattern 151, the first insulating layer 160, the second conductive pattern 152 and the second insulating layer 370 of each sub-electrode 341 are stacked from bottom to top in sequence on the substrate 121. The second insulating layer 370 of each sub-electrode 341 is at least partially uncovered by second conductive pattern 152 along the horizontal direction X. The second insulating layers 370 of each sub-electrode 341 of the embodiment do not contact one another, so as have the liquid crystal layer 130 sufficiently fill the space between the sub-electrodes 341, thereby improving the driving performances of the horizontal electric field formed between the sub-electrodes 341. Apart from the second insulating layer 370, the other components, material properties, and manufacturing methods of the of the liquid crystal display panel 300 are similar to those of the first embodiment detailed above and will not be redundantly described.

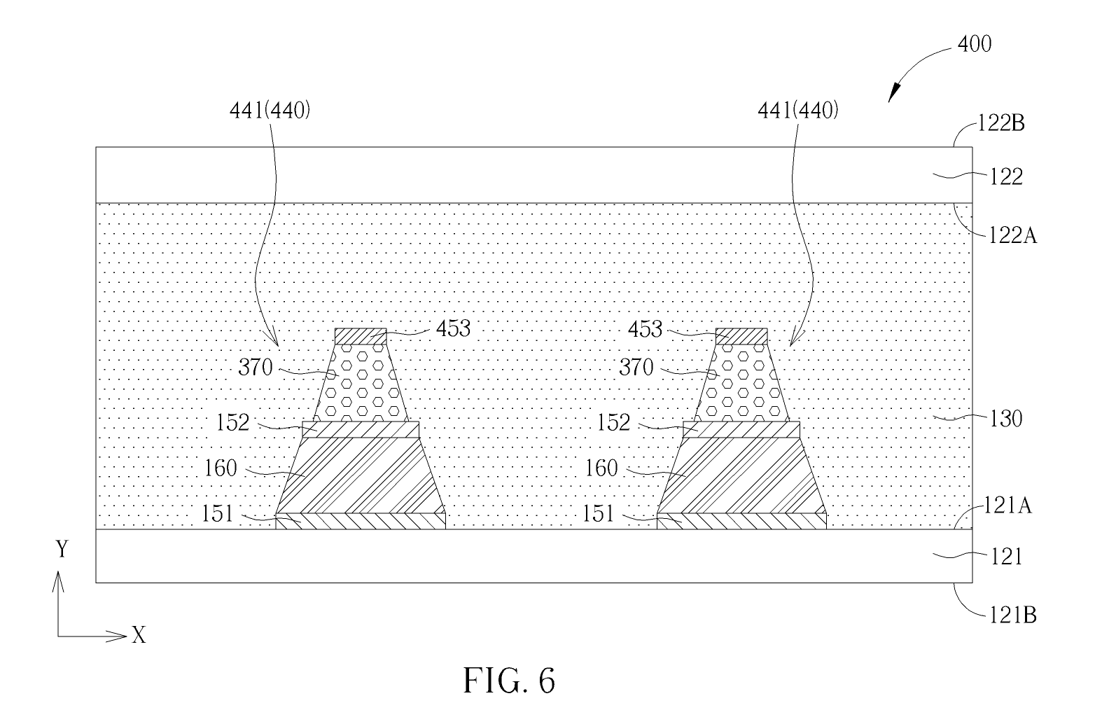

Please refer to FIG. 6; FIG. 6 is a schematic diagram showing a liquid crystal display panel according to the fourth embodiment of the present invention. As shown in FIG. 6, a liquid crystal display panel 400 comprises a first substrate 121, a second substrate 122, a liquid crystal layer 130 and an electrode structure 440. The electrode structure 440 is disposed between the first substrate 121 and the second substrate 122, to form a horizontal electric field for driving the liquid crystal layer 130. The electrode structure 440 includes a plurality of sub-electrodes 441 disposed on the inner surface 121A of the first substrate 121, wherein each the sub-electrode 441 includes a first conductive pattern 151, a second conductive pattern 152 and a first insulating layer 160. The difference between this embodiment and the third embodiment is that, in this embodiment, the sub-electrodes 441 further comprise a third conductive pattern 453 disposed on the second insulating layer 370. Along the vertical projective direction Y, an area of the second conductive pattern 152 is larger than an area of the third conductive pattern 453. In other words, the first conductive pattern 151, the first insulating layer 160, the second conductive pattern 152, the second insulating layer 370 and the third conductive pattern 453 of each sub-electrode 441 are stacked on the substrate 121 from bottom to top in sequence. Through the disposition of the second insulating layer 370 and the third conductive pattern 453 of each sub-electrode 441 that allows the sub-electrodes 441 to be embedded deeper in the liquid crystal layer 130 along the vertical projective direction Y, the driving performances of the horizontal electric field formed between the sub-electrodes 441 to drive the liquid crystal layer 130 are enhanced. Apart from the third conductive pattern 453, the other components, material properties, and manufacturing methods of the of the liquid crystal display panel 400 are similar to those of the third embodiment detailed above and will not be redundantly described.

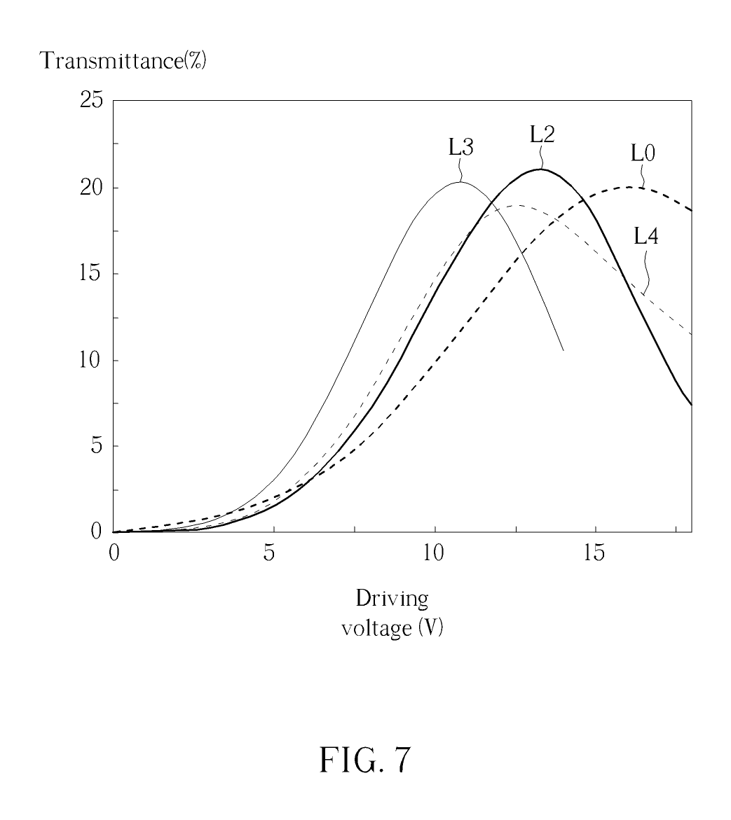

Please refer to FIG. 7, and please refer to FIGS. 1, 2, 5 and 6 together. FIG. 7 is a schematic diagram showing curves about relations between the driving voltage and the transmittance of the liquid crystal display panel according to the second, third and fourth embodiment of the present invention and a liquid crystal display panel of a control group. As shown in FIGS. 1, 2, 5, 6 and 7, the curve L2 represents the curve of the transmittance of the liquid crystal display panel 200 of the second embodiment to the driving voltage; the curve L3 represents the curve of the transmittance of the liquid crystal display panel 300 of the third embodiment to the driving voltage; the curve L4 represents the curve of the transmittance of the liquid crystal display panel 400 of the fourth embodiment to the driving voltage, and the curve L0 represents the transmittance curve of a conventional liquid crystal display panel (used as a control group here) to the driving voltage. FIG. 7 shows that the structure of the different embodiments of the present invention that uses the protrusions shaped sub-electrodes achieves high transmittances in low driving voltages, which can achieve the purpose of reducing the operating voltage and enhance the transmittance.

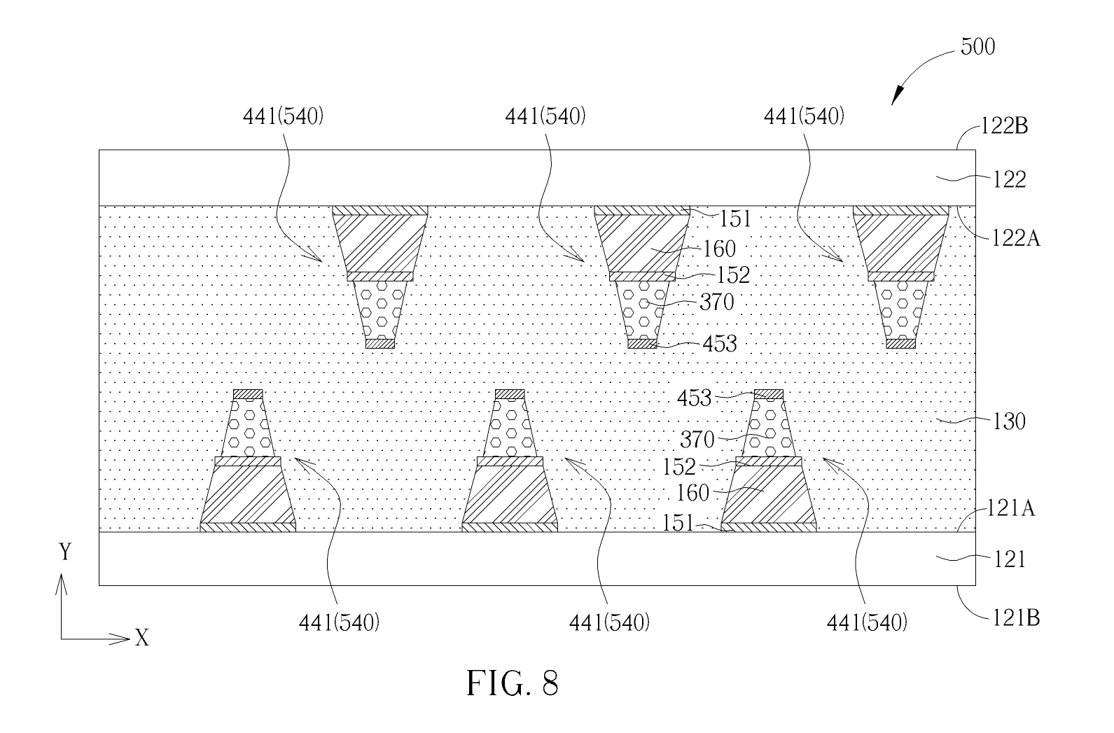

Please refer to FIG. 8. FIG. 8 is a schematic diagram showing a liquid crystal display panel according to the fifth embodiment of the present invention. As shown in FIG. 8, a liquid crystal display panel 500 comprises a first substrate 121, a second substrate 122, a liquid crystal layer 130 and an electrode structure 540. The electrode structure 540 is disposed between the first substrate 121 and the second substrate 122, to form a horizontal electric field for driving the liquid crystal layer 130. The electrode structure 540 includes a plurality of sub-electrodes 441. The difference between this embodiment and the fourth embodiment is that, in the electrode structure 540 of this embodiment, parts of the sub-electrodes 441 are disposed on the inner surface 121A of the first substrate 121, others sub-electrodes 441 are disposed on the inner surface 122A of the second substrate 122; the sub-electrodes 441 on the first substrate 121 and the sub-electrodes 441 on the second substrate 122 are used to generate the horizontal electric field between the sub-electrodes 441 on the first substrate 121, and the sub-electrodes 441 on the second substrate 122 to drive the liquid crystal layer 130. The first conductive pattern 151 of the sub-electrodes 441 on the second substrate 122 is disposed between the second substrate 122 and the first insulating layer 160, and when observed along the vertical projective direction Y from the first substrate 121 side, the second conductive pattern 152 is entirely hidden by the first conductive pattern. The third conductive pattern of the sub-electrode 441 on the second substrate 122 is disposed on the second insulating layer 370, and an area of the second conductive pattern 152 is larger than an area of the third conductive pattern 453. In other words, the first conductive pattern 151, the first insulating layer 160, the second conductive pattern 152, the second insulating layer 370 and the third conductive pattern 453 of each sub-electrode 441 are stacked on the substrate 122 from top to bottom in sequence, but not limited thereto. Apart from the parts of the sub-electrodes 441 that are disposed on the second substrate 122, the other components, material properties, and manufacturing methods of the of the liquid crystal display panel 500 are similar to those of the fourth embodiment detailed above and will not be redundantly described.

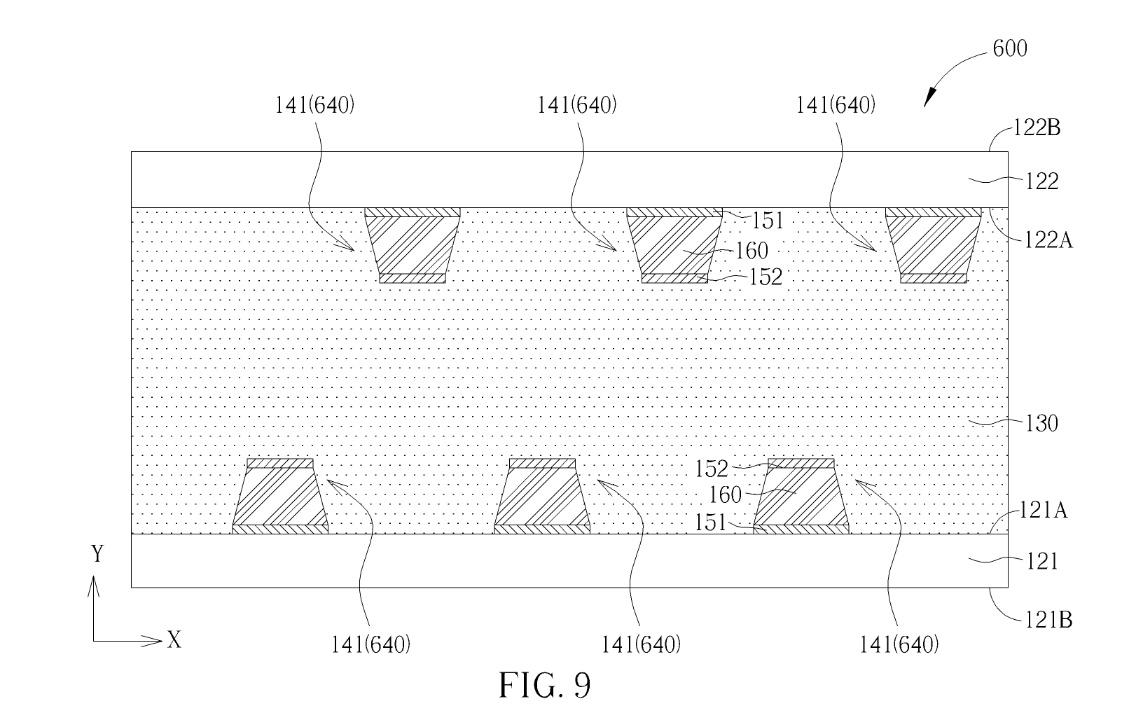

FIG. 9 is a schematic diagram showing a liquid crystal display panel according to the sixth embodiment of the present invention. As shown in FIG. 9, a liquid crystal display panel 600 comprises a first substrate 121, a second substrate 122, a liquid crystal layer 130 and an electrode structure 640. The electrode structure 640 is disposed between the first substrate 121 and the second substrate 122 to form a horizontal electric field for driving the liquid crystal layer 130. The electrode structure 640 includes a plurality of sub-electrodes 141. The difference between this embodiment and the first embodiment is that, in the electrode structure 640 of this embodiment, parts of the sub-electrodes 141 are disposed on the inner surface 121A of the first substrate 121, but others sub-electrodes 141 are disposed on the inner surface 122A of the second substrate 122. The sub-electrodes 141 on the first substrate 121 and the sub-electrodes 141 on the second substrate 122 are used to generate the horizontal electric field between the sub-electrodes 141 on the first substrate 121 and the sub-electrodes 141 on the second substrate 122 to drive the liquid crystal layer 130. Apart from the parts of the sub-electrodes 141 that are disposed on the second substrate 122, the other components, material properties, and manufacturing methods of the of the liquid crystal display panel 600 are similar to those of the first embodiment detailed above and will not be redundantly described. It is worth noting that, the first conductive pattern 151, the first insulating layer 160 and the second conductive pattern 152 of each sub-electrode 141 are stacked on the substrate 122 from top to bottom in sequence, but not limited thereto.

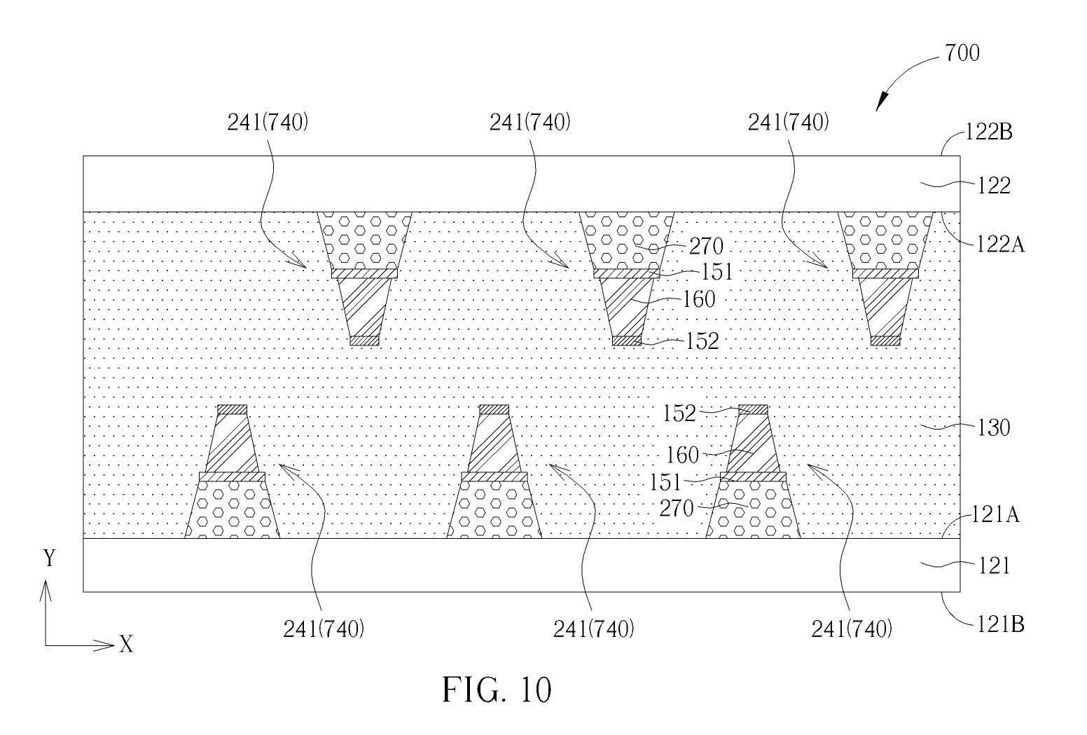

FIG. 10 is a schematic diagram showing a liquid crystal display panel according to the seventh embodiment of the present invention. As shown in FIG. 10, a liquid crystal display panel 700 comprises a first substrate 121, a second substrate 122, a liquid crystal layer 130 and an electrode structure 740. The electrode structure 640 is disposed between the first substrate 121 and the second substrate 122 to form a horizontal electric field for driving the liquid crystal layer 130. The electrode structure 740 includes a plurality of sub-electrodes 241. The difference between this embodiment and the second embodiment is that, in the electrode structure 740 of this embodiment, parts of the sub-electrodes 241 are disposed on the inner surface 121A of the first substrate 121, others sub-electrodes 241 are disposed on the inner surface 122A of the second substrate 122, the sub-electrodes 241 on the first substrate 121 and the sub-electrodes 241 on the second substrate 122 are used to generate the horizontal electric field between the sub-electrodes 241 on the first substrate 121 and the sub-electrodes 241 on the second substrate 122 for driving the liquid crystal layer 130. The second insulating layer 270 of each sub-electrode 241 on the second substrate 122 is disposed between the second substrate 122 and the first conductive pattern 151, and the second insulating layer 270 of each sub-electrode 241 on the second substrate 122 at least partially uncovered by the first conductive pattern 151 and the second conductive pattern 152 along the horizontal direction X. In other words, the second insulating layer 270, the first conductive pattern 151, the first insulating layer 160 and the second conductive pattern 152 of each sub-electrode 241 are stacked on the substrate from top to bottom in sequence 122, but not limited thereto. Apart from the parts of the sub-electrodes 241 that are disposed on the second substrate 122, the other components, material properties, and manufacturing methods of the of the liquid crystal display panel 700 are similar to those of the second embodiment detailed above and will not be redundantly described.

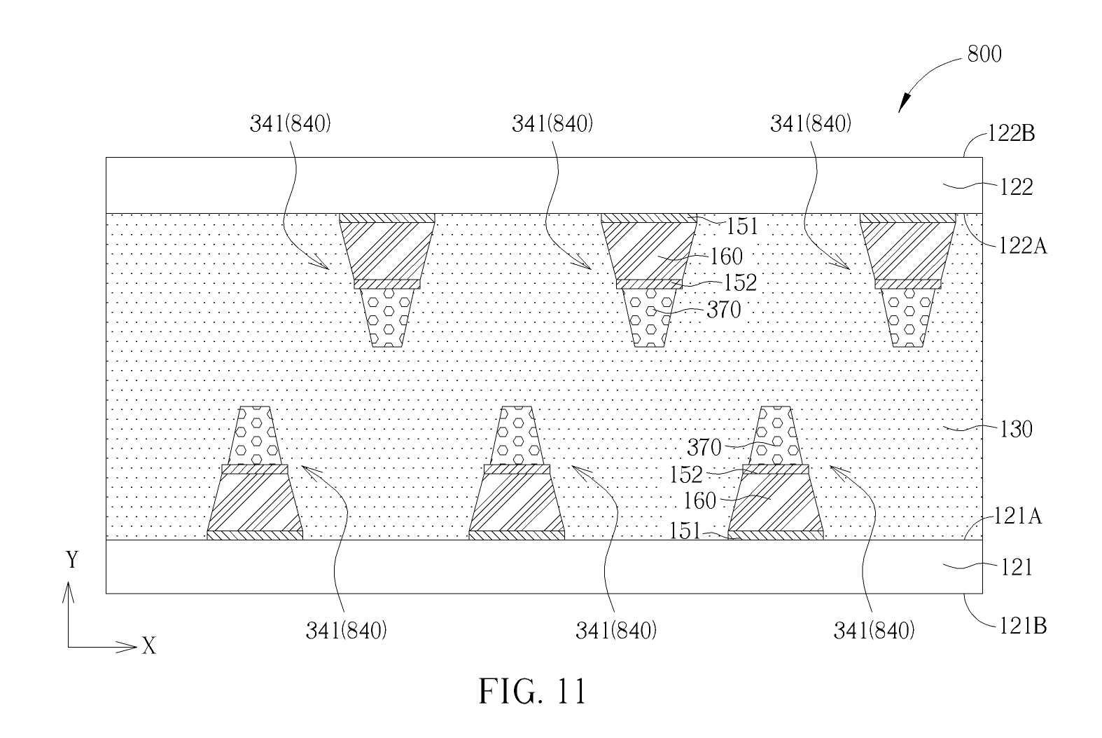

FIG. 11 is a schematic diagram showing liquid crystal display panel according to the eighth embodiment of the present invention. As shown in FIG. 11, a liquid crystal display panel 800 comprises a first substrate 121, a second substrate 122, a liquid crystal layer 130 and an electrode structure 840. The electrode structure 840 is disposed between the first substrate 121 and the second substrate 122, to form a horizontal electric field for driving the liquid crystal layer 130. The electrode structure 840 includes a plurality of the sub-electrode 341. The difference between this embodiment and the fourth embodiment is that, in the electrode structure 840 of this embodiment, parts of the sub-electrodes 341 are disposed on the inner surface 121A of the first substrate 121, and others sub-electrodes 341 are disposed on the inner surface 122A of the second substrate 122. The sub-electrodes 341 on the first substrate 121 and the sub-electrodes 341 on the second substrate 122 are used to generate the horizontal electric field between the sub-electrodes 341 on the first substrate 121 and the sub-electrodes 341 on the second substrate 122 for driving the liquid crystal layer 130. The second insulating layer 370 of the sub-electrode 341 on the second substrate 122 is disposed on the second conductive pattern 152, and the second insulating layer 370 of each sub-electrode 341 on the second substrate 122 at least partially uncovered by the second conductive pattern 152 along the horizontal direction X. In other words, the first conductive pattern 151, the first insulating layer 160, the second conductive pattern 152 and the second insulating layer 270 of each sub-electrode 341 are stacked on the substrate 122 from top to bottom in sequence, but not limited thereto. Apart from the parts of the sub-electrodes 341 that are disposed on the second substrate 122, the other components, material properties, and manufacturing methods of the of the liquid crystal display panel 800 are similar to those of the third embodiment detailed above and will not be redundantly described.

In summary, the present invention provides a liquid crystal display panel, using an insulating layer disposed between two conductive patterns to form protrusion shaped sub-electrodes, and to enhance the horizontal electric field formed between the sub-electrodes, so as to achieve the purpose of reducing operating voltage. In addition, the operating voltage can be reduced and the transmittance can be improved under normally black status.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A liquid crystal display panel comprising:
a first substrate;
a second substrate, disposed opposite to the first substrate;
a liquid crystal layer disposed between the first substrate and the second substrate; and
an electrode structure disposed between the first substrate and the second substrate, and the electrode structure is configured to generate a horizontal electric field for driving the liquid crystal layer, wherein the electrode structure includes a plurality of sub-electrodes, each of the sub-electrodes comprising:
a first conductive pattern;
a second conductive pattern, wherein the first conductive pattern and the second conductive pattern are disposed in a stack configuration along a vertical projective direction perpendicular to the first substrate and the second substrate, and an area of the first conductive pattern is larger than an area of the second conductive pattern; and
a first insulating layer disposed between the first conductive pattern and the second conductive pattern.

2. The liquid crystal display panel of claim 1, wherein at least parts of the sub-electrodes are disposed on the first substrate, and the horizontal electric field is generated between the sub-electrodes on the first substrate.

3. The liquid crystal display panel of claim 2, wherein the first conductive pattern of each sub-electrode disposed on the first substrate is disposed between the first substrate and the first insulating layer, and the second conductive pattern is entirely hidden by the first conductive pattern in the vertical projective direction when observed from the first substrate.

4. The liquid crystal display panel of claim 1, wherein the first insulating layer of each sub-electrode is at least partially uncovered by the second conductive pattern along a horizontal direction parallel to the first substrate and the second substrate.

5. The liquid crystal display panel of claim 2, wherein each sub-electrode on the first substrate further comprises a second insulating layer disposed between the first substrate and the first conductive pattern.

6. The liquid crystal display panel of claim 5, wherein the second insulating layer of each sub-electrode on the first substrate is at least partially uncovered by the first conductive pattern and the second conductive pattern along a horizontal direction parallel to the first substrate and the second substrate.

7. The liquid crystal display panel of claim 2, wherein each sub-electrode on the first substrate further comprises a second insulating layer disposed on the second conductive pattern.

8. The liquid crystal display panel of claim 7, wherein the second insulating layer of each sub-electrode on the first substrate is at least partially uncovered by the second conductive pattern along a horizontal direction parallel to the first substrate and the second substrate.

9. The liquid crystal display panel of claim 7, wherein each sub-electrode on the first substrate further comprises a third conductive pattern disposed on the second insulating layer, wherein the area of the second conductive pattern is larger than an area of the third conductive pattern along the vertical projective direction.

10. The liquid crystal display panel of claim 1, wherein the first conductive pattern of each sub-electrode is electrically connected to the second conductive pattern.

11. The liquid crystal display panel of claim 1, wherein the first conductive pattern of each sub-electrode is electrically isolated from the second conductive pattern.

12. The liquid crystal display panel of claim 1, wherein a same driving voltage is applied to the first conductive pattern and the second conductive pattern of each sub-electrode.

13. The liquid crystal display panel of claim 12, wherein the driving voltage comprises a positive driving voltage, a negative driving voltage or a common voltage.

14. The liquid crystal display panel of claim 1, wherein different driving voltages are applied to the first conductive pattern and the second conductive pattern of each sub-electrode.

15. The liquid crystal display panel of claim 1, wherein a distance between the first conductive pattern and the second conductive pattern is larger than or equal to 0.1 micrometer.

16. The liquid crystal display panel of claim 1, wherein a distance between two adjacent sub-electrodes is larger than or equal to 0.5 micrometer.

17. The liquid crystal display panel of claim 1, wherein the liquid crystal layer is optically isotropic when no electric field is applied to the liquid crystal layer.

18. The liquid crystal display panel of claim 1, wherein the liquid crystal layer comprises blue-phase liquid crystal or nematic liquid crystal.

19. The liquid crystal display panel of claim 1, wherein the sub-electrodes are disposed on the first substrate, and the horizontal electric field is generated between at least parts of the sub-electrodes.

20. The liquid crystal display panel of claim 1, wherein at least parts of the sub-electrodes are disposed on the first substrate, at least parts of the sub-electrodes are disposed on the second substrate, and the horizontal electric field is generated between the sub-electrodes on the first substrate and the sub-electrodes on the second substrate.

21. The liquid crystal display panel of claim 20, wherein the first conductive pattern of each sub-electrode on the second substrate is disposed between the second substrate and the first insulating layer, and the second conductive pattern is entirely hidden by the first conductive pattern in the vertical projective direction when observed from the first substrate.

22. The liquid crystal display panel of claim 20, wherein each sub-electrode on the second substrate further comprises a second insulating layer disposed between the second substrate and the first conductive pattern.

23. The liquid crystal display panel of claim 22, wherein the second insulating of each sub-electrode on the second substrate is at least partially uncovered by the first conductive pattern and the second conductive pattern along a horizontal direction parallel to the first substrate and the second substrate.

24. The liquid crystal display panel of claim 20, wherein each sub-electrode on the second substrate further comprises a second insulating layer disposed on the second conductive pattern.

25. The liquid crystal display panel of claim 24, wherein the second insulating layer of each sub-electrode on the second substrate is at least partially uncovered by the second conductive pattern along a horizontal direction parallel to the first substrate and the second substrate.

26. The liquid crystal display panel of claim 25, wherein each sub-electrode on the second substrate further comprises a third conductive pattern disposed on the second insulating layer, wherein the area of the second conductive pattern is larger than an area of the third conductive pattern along a vertical projective direction.
